(19) United States
(12) Patent Application Publication
(10) Pub. No.: US 2004/0268394 A1
(43) Pub. Date: Dec. 30, 2004

(54) Compressing and decompressing EPG data

(75) Inventors: Tim Nichols, Los Altos, CA (US); Steven Wasserman, Mountain View, CA (US); Grant Mohr, San Bruno, CA (US)

Correspondence Address: LEE & HAYES PLLC, 421 W RIVERSIDE AVENUE SUITE 500, SPOKANE, WA, 99201

(73) Assignee: MICROSOFT CORPORATION, REDMOND, WA (US)

(21) Appl. No.: 10/610,412

(22) Filed: Jun. 27, 2003

(51) Int. Cl. H04N 5/445; G06F 3/00; G06F 13/00

(52) U.S. Cl. 725/45; 725/46

(57) ABSTRACT

a method is described which may be used to compress EPG data. EPG data may include a plurality of television programs. Each television program may have one or more values that respectively describe one or more television program characteristics. In one implementation, the EPG data is compressed by comparing the one or more values of each said television program with unique combinations of values to find a match. Each value in each unique combination describes a television program characteristic. Each of said unique combinations is in a table that includes a plurality of identifiers, and wherein each said identifier references one said unique combinations. For each said match, one or more values of the television program are replaced with an identifier in the table that references the matching unique combination of values.

### TECHNICAL FIELD

The present invention generally relates to electronic program guides and more particularly to compressing and decompressing electronic program guide data.

### BACKGROUND

Viewers have access to an ever-increasing amount of television programming due to a growing variety of television programs and an increasing number of television stations. Although the amount of television programming has increased, viewers may encounter difficulties in accessing desired television programs. For example, a viewer may be unable to locate a desired television program due to the number of television channels that are available to the viewer. Therefore, the viewer may not be able to fully experience the television programming as desired.

An electronic program guide (EPG) may be supplied to improve the viewer's experience with television programs. The EPG may enable the viewer to observe a listing of television programs that are currently being broadcast, as well as a listing of television programs that will be broadcast in the future. Additionally, the EPG may allow the viewer to navigate to a television program from the EPG itself. To provide additional information to the viewer, the EPG may include one or more television program characteristics that describe a television program in the EPG. The television program characteristics may include title, broadcast time, broadcast channel, duration, description of the television program, a rating for the television program (e.g., G, PG, PG13, R, etc.), the principle protagonist's name, and so on.

EPG data is used to construct an EPG. EPG data may be generated by an EPG provider from data obtained from a publisher of the television programming. The data is generally transmitted to the EPG provider from the publisher using a national guide feed. The national guide feed is provided over a high bandwidth connection from the publisher to a head end of the EPG provider, and generally includes a large amount of data. A connection is also provided between the head end and the client device such that the client device may receive EPG data generated by the EPG provider. The connection between the head end and the client device, however, may have a significantly lower bandwidth than the bandwidth of the national guide feed provided between the head end and the publisher. Additionally, the EPG data is stored in memory of the client device. Therefore, the amount of EPG data that can be stored at the client device is dependent upon the memory of the client device. If the client device is a low-resource client device, meaning the client device has limited memory, the amount of memory reserved for EPG data and the availability of that memory to provide other functionality is limited.

Therefore, there is a need to improve EPG communication and storage at a client device.

### SUMMARY

Compressing and decompressing electronic program guide (EPG) data is described. EPG data may include a plurality of television programs. Each television program may have one or more values that respectively describe one or more television program characteristics. In one implementation, the EPG data is compressed by comparing the one or more values of each television program with unique combinations of values that describe respective television program characteristics to find a match. Each of the unique combinations is in a table that includes a plurality of identifiers that reference one of the unique combinations. For each match, one or more values of the corresponding television program in the EPG data are replaced with an identifier in the table that references the matching unique combination of values.

The compressed EPG data may be decompressed by a client device that executes a decompression routine. The client device includes the table and the compressed EPG data. When the decompression routine is executed, the one or more identifiers of the television programs are compared with the identifiers in the table. When there is a match, at least one value is output from the unique combination of values referenced by the matching identifier in the table.

In another implementation, the EPG data is compressed by comparing the one or more values of each television program with values in a table that describe a television program characteristic. Each of the values in the table is referenced by an identifier. When the one or more values of each television program match one of the values in the table, the one or more values of each television program are replaced with an identifier that matches the identifier that references the matching value in the table. When the one or more values of each television program do not match any of the values in the table, a read identifier is inserted with the one or more values of each television program in the EPG data. The read identifier references the one or more values of each television program.

The compressed EPG data may be decompressed by a client device that executes a decompression routine. The client device includes the table and the compressed EPG data. When the decompression routine is executed, an identifier of a television program in the compressed EPG data is analyzed. If the identifier of the television program is a read identifier, then the value referenced by the read identifier is output from the compressed EPG data. If the identifier of the television program is not a read identifier, then the identifier of the television program is compared to the identifiers in the table. When there is a match, the value referenced by the matching identifier in the table is output from the table.

In a further implementation, a broadcast start time for each television program in an EPG is computed by a client device using a master start time. To do so, the duration of each television program in the EPG is added to the master start time to compute the star time for each television program. The start times of the television programs in the EPG may then be output for display to a TV viewer.

### BRIEF DESCRIPTION OF THE DRAWINGS

FIG. 1 is an illustration showing a television entertainment system that includes a publisher and a client device.

FIG. 2 is an illustration showing an exemplary implementation wherein common values of a television program characteristic “duration” shown in FIG. 1 are included in a table.

FIG. 3 is an illustration showing an exemplary procedure for generating the table of FIG. 2.

FIG. 4 is an illustration showing an exemplary procedure for using the table generated by the procedure of FIG. 3 to compress EPG data.

FIG. 5 illustrates an exemplary procedure in which the client device executes a decompression routine to decompress the compressed EPG data of FIG. 4 using the table generated in FIG. 3.

FIG. 6 illustrates an exemplary implementation showing a description of common and uncommon values in the compressed EPG data of FIG. 4 with corresponding television programs.

FIG. 7 is an illustration showing an exemplary implementation of a master start time that, when utilized in conjunction with values of a duration television program characteristic, is suitable to enable a client device to compute a start time for a desired television program.

FIG. 8 is an illustration showing an exemplary implementation of combining values of television program characteristics in a table.

FIG. 9 is an illustration showing an exemplary procedure in which the table of FIG. 8 is generated that includes identifiers, each of which reference combinations of the values of the television program characteristics.

FIG. 10 is an illustration of an exemplary procedure for compressing combinations of values contained in EPG data using the table generated in FIG. 9.

FIG. 11 is an illustration showing an exemplary procedure in which the client device executes a decompression routine to decompress the compressed EPG data of FIG. 10 using the table of FIG. 9.

FIG. 12 illustrates an exemplary television entertainment system in which EPG data compression and decompression may be implemented.

FIG. 13 illustrates selected components of the television entertainment system of FIG. 12, such as an exemplary client device and a television.

### DETAILED DESCRIPTION

Overview

The following discussion is directed to compressing and decompressing electronic program guide (EPG) data. EPG data may be provided in television entertainment systems, such as interactive television networks, cable networks that utilize EPGs, and Web-enabled television networks. Client devices in such systems range from full resource client devices with substantial memory and processor resources (e.g., television enabled personal computers, television recorders equipped with hard disk) to low-resource client devices with limited memory and/or processing resources (e.g., traditional set-top boxes). While aspects of the system and methods described below may be used in any of these systems and for any type of client device, they are particularly well suited for systems with low-resource client devices. Hence, portions of the following discussion describes the systems and methods in the context of a low-resource environment.

To simplify the following discussion, references to a “television program characteristic” will be shorted to a “characteristic.” Additionally, although television programs will be discussed, television programs are not limited to traditional programming by television networks, but may also include video-on-demand (VOD), broadcast movies, pay-per-view programming, and the like.

Television Entertainment System

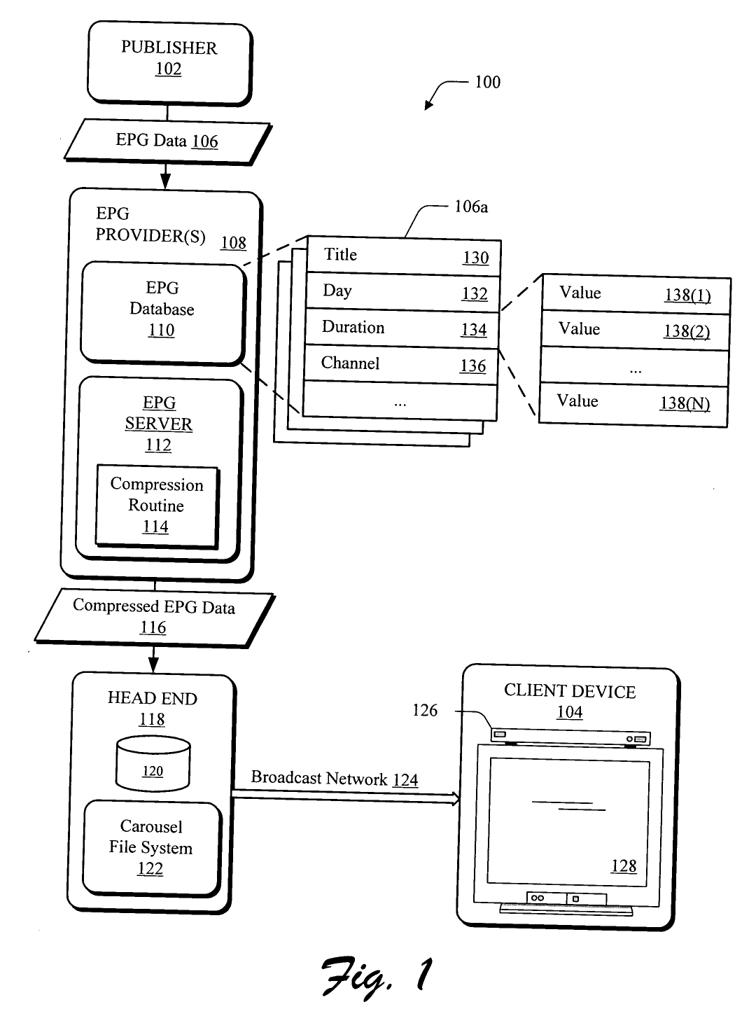

FIG. 1 is an illustration showing a television entertainment system 100 that includes a publisher 102 and a client device 104. The publisher 102 creates EPG data 106 for distribution to the client device 104. One example of a publisher 102 is the Tribune Corporation, which generates EPG data for interactive television networks. As used herein, EPG data refers to a type of data that might be used to construct an EPG. EPG data includes characteristics of television programs broadcast by a content provider. The characteristics may include title, broadcast time, broadcast channel, duration, description of the television program, a rating for the television program (e.g., G, PG, PG13, R, etc.), the principle protagonist's name, and so on.

The EPG data 106 is transferred as an electronic file from the publisher 102 to an EPG provider 108. As one example, the EPG data 106 is transferred using a file transfer protocol (FTP) over a TCP/IP network (e.g., Internet, UNIX, etc.) to the EPG provider 108. The EPG data 106 is stored in an EPG database 110 at the EPG provider 108.

The original version of the EPG data 106 contains all of the programming information for multiple days. An EPG server 112 is in communication with the EPG provider 108 to process the EPG data 106 prior to distribution. The processing involves one or more techniques to condition the EPG data 106 so that the client device 104 may handle the EPG data 106 more effectively. The client device 104 may be configured in a variety of ways, such as a set-top box or other low-resource client device that is typically characterized as having limited memory and/or processing resources. Such a client device 104 may not have sufficient resources to be able to store the entire original version of the EPG data 106. With limited resources at the client device 104, the processes performed by the EPG server 112 are helpful to precondition the EPG data 106 into a more suitable form for storage and processing at the client device 104.

Among other processes, the EPG server 112 is configured to reduce the amount of EPG data 106 so that it can be stored at the client device 104 even if the client device 104 has limited resources. For example, the EPG server 112 may compress the EPG data 106 prior to its distribution by using a compression routine 114. The compression routine 114 may be implemented as software that is used to compress the EPG data 106 for communication to the client device 104.

The EPG server 112 provides compressed EPG data 116 formed from the EPG data 106 to a head end 118 for storage in a database 120 of the head end 118. A carousel file system 122 repeatedly broadcasts the compressed EPG data 116 over an out-of-band (OOB) channel to the client device 104 over a broadcast network 124. Distribution from the head end 118 to the client device 104 may be accommodated in a number of ways, including cable, RF, microwave, and satellite. Although the head end 118 is illustrated as separate from the EPG provider 108, the EPG provider 108 may also include the head end 118 which includes the EPG server 112. Additionally, the EPG server 112 may be included as part of the publisher 102 that provides the EPG data 106.

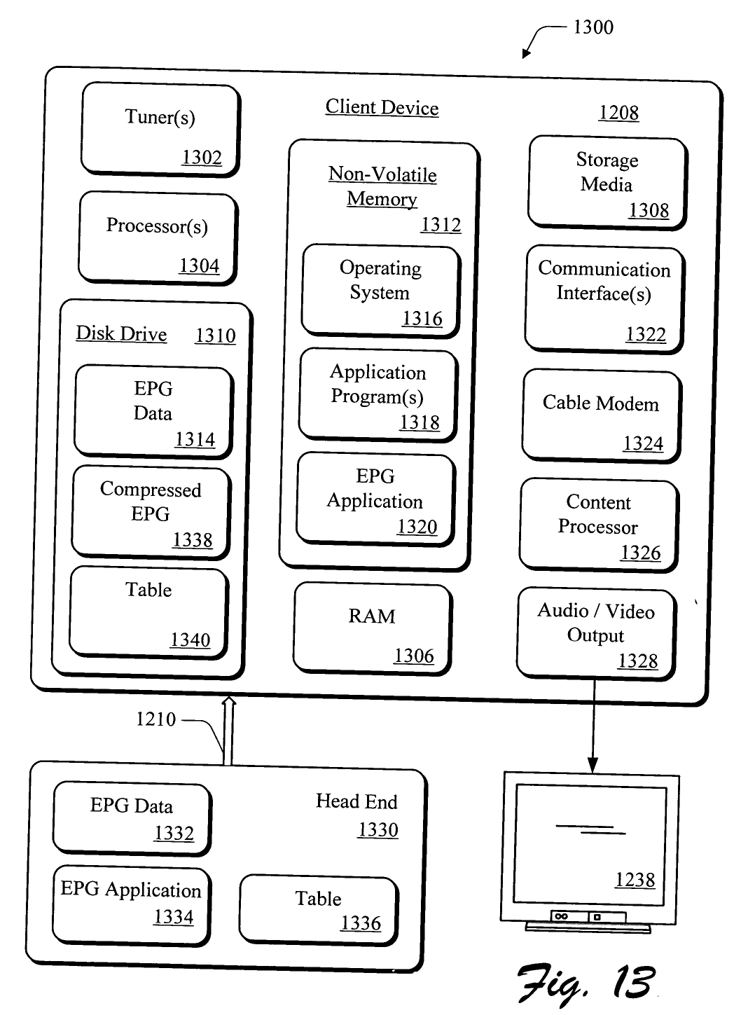

In the illustrated implementation, the client device 104 is implemented as a set-top box 126 connected to a display device 128. The client device 104 is often equipped with sufficient processing and storage capabilities to store and run an operating system and a few programs. Examples of programs stored on the client device 104 might include a Web browser, an electronic programming guide, a personal scheduler, and so forth. Although the set-top box 126 is shown separately from the display device 128, they may alternatively be built into the display device 128 as integral units. Furthermore, in other implementations, the client device 104 may be embodied as other devices capable of handling EPG data, such as a broadcast-enabled computer, an information appliance, or the like. An additional discussion of the client device 104 may be found in relation to FIGS. 12-13.

EPG data 106a stored at the EPG database 110 may include a variety of characteristics 130-136 that describe television programs. For example, the characteristics may include title 130, day 132 that a television program is to be broadcast (i.e. Sunday), duration 134 of the broadcast of the television program, channel 136 that the television program will be broadcast on, and so forth. Additionally, each of the characteristics 130-136 may have a plurality of values. For example, television programs that are broadcast by a content provider may have different values 138(1)-138(N) for the duration 134 characteristic. Additionally, a value may describe a binary condition for a characteristic, such as whether the television program contains or does not contain the characteristic, such as adult language or violence.

Compressing Common Values of a Characteristic

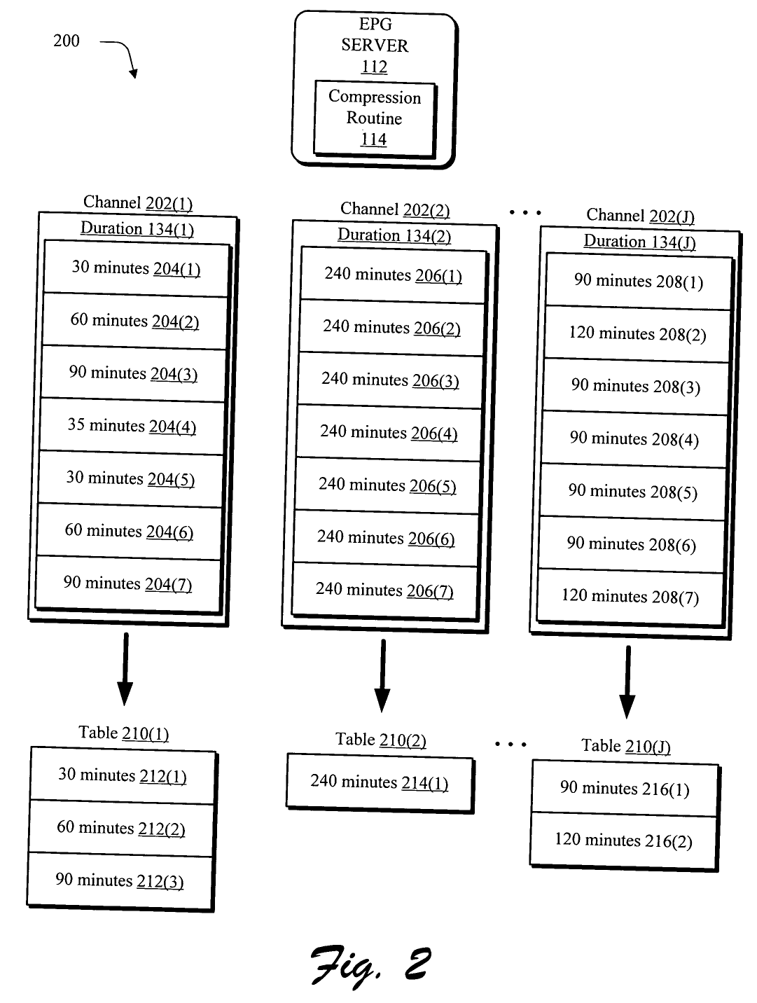

Even though EPG data may have a wide range of characteristics having an even wider range of values, a small number of values may be utilized in most occurrences of the characteristic in EPG data. For example, FIG. 2 is an illustration showing an exemplary implementation 200 of values for the characteristic duration 134 shown in FIG. 1. Although television programs may have durations from one minute to 1440 minutes (24 hours), EPG data for the duration 134 may include a limited number of values that occur frequently. These values may differ for different channels 202(1)-202(J). For instance, channel 202(1) may be a typical television network station that has the characteristic duration 134(1). Channel 202(1) broadcasts television programs having values of 30 minutes [204(1), 204(5)], 60 minutes [204(2), 204(6)], and 90 minutes [204(3), 204(7)], but not many other values, such as 35 minutes 204(4). Likewise, channel 202(2) may be a cable news or weather channel that also has a duration 134(2). Channel 202(2) has multiple values of 240 minutes 206(1)-206(7) for the duration 134(2). Channel 202(J) may be a movie channel that broadcasts movies having values of 90 minutes [208(1), 208(3), 208(4), 208(5), 208(6)], or 120 minutes [208(2), 208(7)] for the duration 134(J).

The EPG server 112 may execute the compression routine 114 to generate tables 210(1)-210(J) that include values that are common for a characteristic of the channels 202(1)-202(J). For example, table 210(1) may include values of 30, 60 and 90 minutes 212(1)-212(3) that are common for the duration 134(1) of channel 202(1). Table 210(2) includes a single value of 240 minutes 214(1) for the duration 134(2) of channel 202(2). Table 210(J) includes two values, 90 minutes 216(1) and 120 minutes 216(2), that are common for the duration 134(J) of channel 202(J).

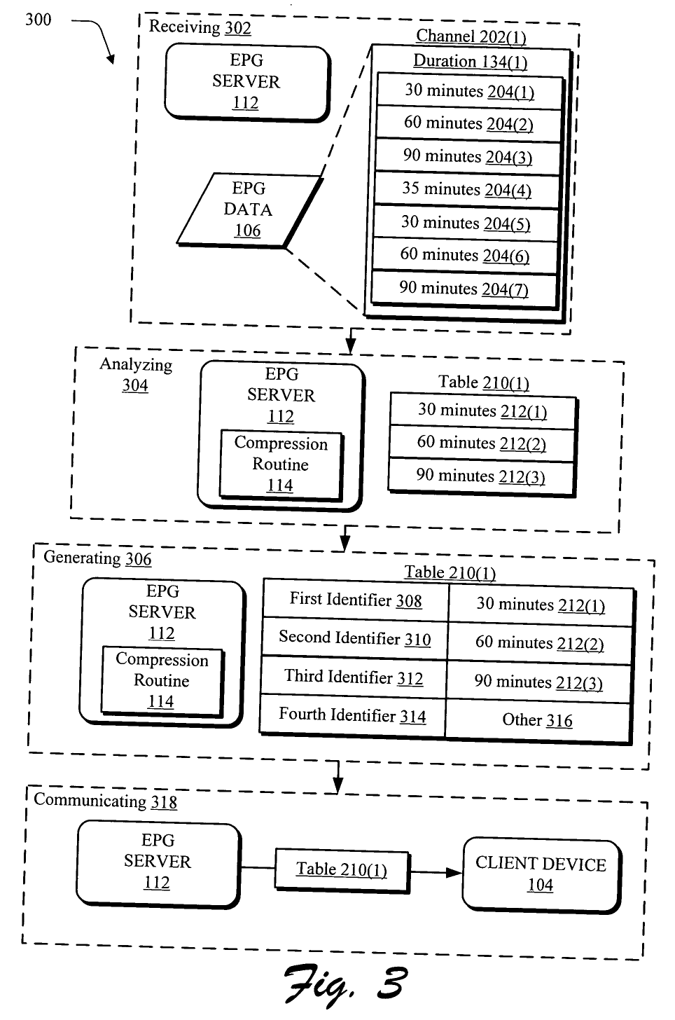

The values contained in the tables 210(1)-210(J) may be referenced to provide compressed EPG data, instead of providing the actual value. Therefore, instead of transmitting actual values 204(1)-204(7), 206(1)-206(7), 208(1)-208(7) for the durations 134(1)-134(J), the values 212(1)-212(3), 214(1), 216(1)-216(2) in the tables 210(1)-210(J) may be referenced to supply the value. A further discussion of generating a table that references the values and using the table to compress and/or decompress EPG data may be found in relation to FIGS. 3-5.

FIG. 3 is an illustration showing an exemplary procedure 300 for generating the table 210(1) of FIG. 2 having values that are common to the duration 134(1). At block 302, a receiving step is shown wherein the EPG server 112 receives EPG data 106 for channel 202(1). The EPG data 106 includes the duration 134(1) that includes values 204(1)-204(7) that describe television programs to be broadcast on channel 202(1). In other words, the EPG data 106 includes a characteristic, e.g. duration 134(1), and values 204(1)-204(7) that describe the characteristic, e.g. how many minutes each television program is to be broadcast.

At block 304, an analyzing step is shown wherein the EPG server 112 executes the compression routine 114 to analyze the values 204(1)-204(7) of the duration 134(1). The values 204(1)-204(7) are analyzed to find common values. The common values are placed in table 210(1). For example, the values of 30 minutes 212(1), 60 minutes 212(2), and 90 minutes 212(3) are placed in table 210(1) to describe values of the duration 134(1) that are common in channel 202(1).

Common values may be found in a variety of ways. For example, a counter may be employed that counts the occurrences of each value for a characteristic included in EPG data 106. Additionally, an amount of memory used to store the values in the EPG data may be used to select values to be included in the table. For example, a bit size of the values may be utilized in conjunction with the number of occurrences of the values in the EPG data to optimize compression. The bit size of each value, for instance, may be multiplied by the number of occurrences of each value in the EPG data 106 to derive values that, when replaced, would have the greatest compressive effect on the EPG data.

At block 306, a generating step is shown wherein the EPG server 112 executes the compression routine 114 to supply identifiers 308-312 in table 210(1) that reference the values 212(1)-212(3). In the illustrated example, three common values are found. Therefore each of the identifiers 308-312 may be configured as two-bits which may be used to reference the values 212(1)-212(3), such that, when the values 212(1)-212(3) are replaced with the identifiers 308-312, the EPG data is compressed. For example, a first identifier 308 may use bits “00” to reference the 12-bit value of 30 minutes 212(1) in the table 210(1). A second identifier 310 may use bits “01” to reference the 12-bit value of 60 minutes 212(2). Likewise, a third identifier 312 may use bits “10” to reference the 12-bit value of 90 minutes 212(3).

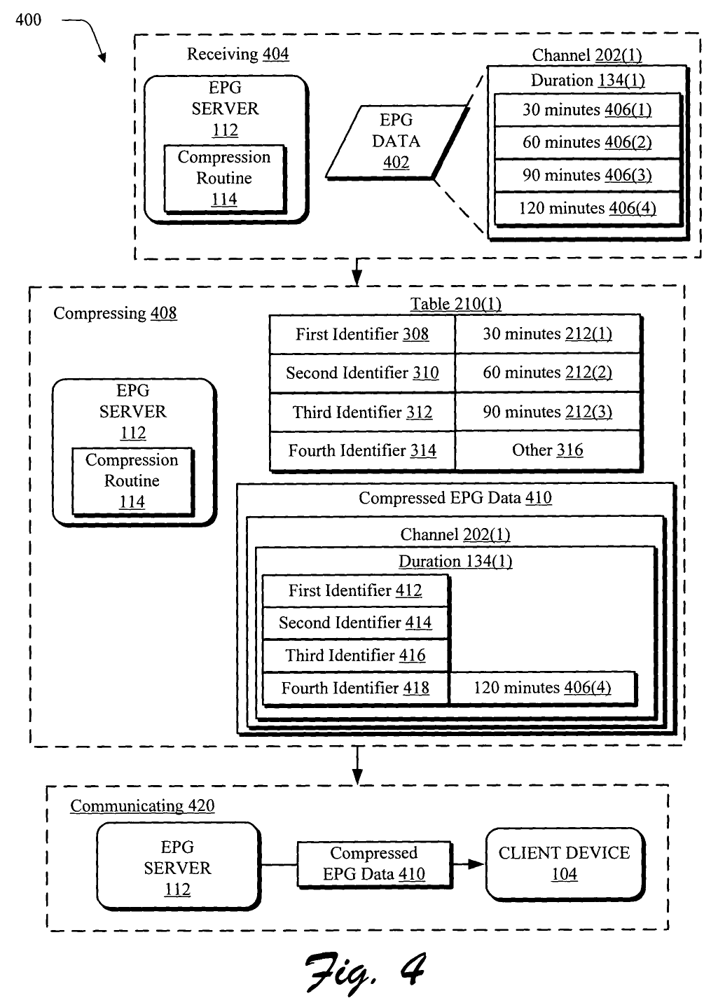

Even though channel 202(1) may include common values for the duration 134(1) characteristic, there may be a value which is not common and therefore is not included in the table 210(1), such as 35 minutes 204(4). To provide a description of an uncommon value, the table 210(1) includes a read identifier to reference a value that is not compressed. For example, the read identifier in table 210(1) is illustrated as a fourth identifier 314, which may use bits “11” to reference a value of “other” 316. The fourth identifier 314 is included in the table 210(1) so that when the table 210(1) is used to compress values in EPG data, the fourth identifier 208(4) is inserted with values that are not included in the table 210(1). By indicating that the value is not included in the table 210(1), the fourth identifier 314 may be utilized to indicate that the value is to be read directly from compressed EPG data itself, rather than from the table 210(1). A further discussion of use of the fourth identifier 314 to compress EPG data may be found in relation to FIG. 4.

At block 318, a communicating step is shown wherein the EPG server 112 communicates the table 210(1) to the client device 104. The table 210(1) may be communicated to the client device in a variety of ways. For example, the table 210(1) may be broadcast using the carousel file system 122 over the broadcast network 124 shown in FIG. 1. Additionally, the table 210(1) may be received by the client device 104 during manufacture, such as when other software is installed on the client device 104. 100431 FIG. 4 is an illustration showing an exemplary procedure 400 for using the table 210(1) generated by the procedure 300 of FIG. 3 to compress values in EPG data 402. At block 404, a receiving step is shown wherein the EPG server 112 receives EPG data 402 for channel 202(1) that has the characteristic duration 134(1). The duration 134(1) has a plurality of values 406(1)-406(4), including 30 minutes 406(1), 60 minutes 406(2), 90 minutes 406(3) and 120 minutes 406(4).

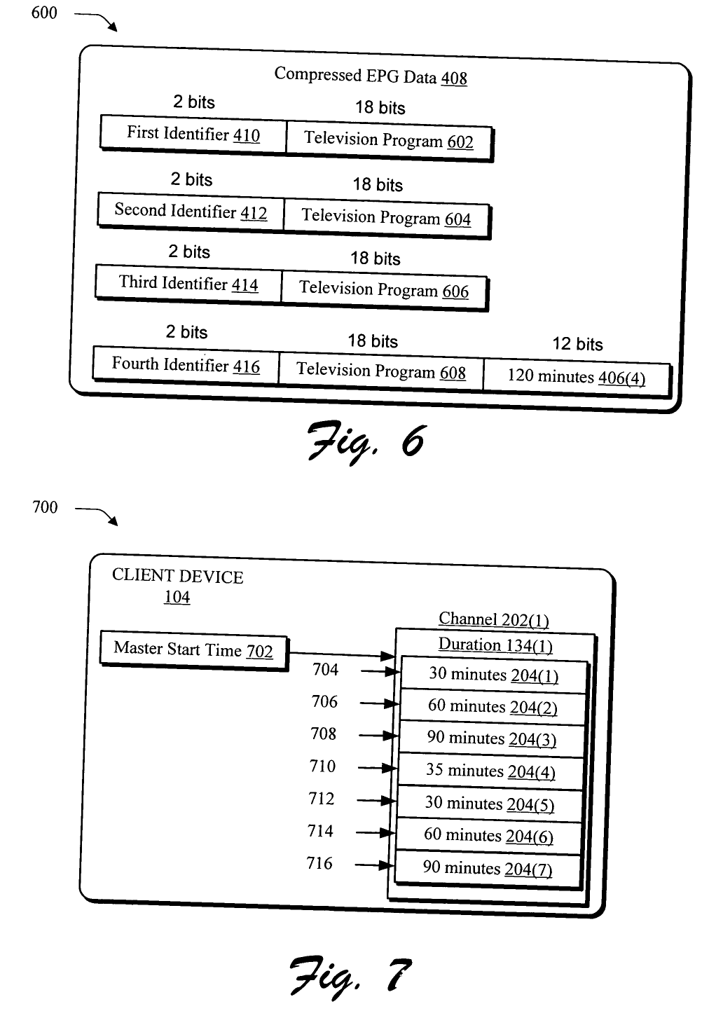

At block 408, a compressing step is shown wherein the EPG server 112 executes the compression routine 114 to compress the EPG data 402 to form compressed EPG data 410. The compression routine 114, when executed, compares the values 406(1)-406(4) of the EPG data 106 with the values 212(1)-212(3) of the table 210(1). If any of the values 406(1)-406(4) of the EPG data 402 match one of the values 212(1)-212(3) in the table 210(1), the value is replaced with an identifier that matches the identifier in the table 210(1) that references the value. For example, the value 30 minutes 406(1) matches the 30 minutes value 212(1) of table 210(1). Therefore, the 30 minutes 406(1) value is replaced with a first identifier 412 that matches the first identifier 308 of the table 210(1). Likewise, second and third identifiers 414, 416 are used to replace the values 60 minutes 406(2) and 90 minutes 406(3), respectively. The value 120 minutes 406(4), however, does not match any of the values 212(1)-212(3) in the table 210(1), but rather, is an “other” 316 value. Therefore, a fourth identifier 418, i.e. a read identifier, is inserted with the value 120 minutes 406(4) in the compressed EPG data 410. The fourth identifier 418 references the value 120 minutes 406(4) in the compressed EPG data 410. For example, the fourth identifier 418 may be used to indicate that the value 120 minutes 406(4) immediately follows the fourth identifier 418 in a string. In this way, the fourth identifier 418 indicates that the value 120 minutes 406(4) is to be read from the compressed EPG data 410 directly, instead of from the table 210(1). FIG. 6 illustrates an exemplary implementation 600 showing the description of common and uncommon values in the compressed EPG data 410 of FIG. 4 with corresponding television programs 602-608. At block 420 of FIG. 4, a communicating step is shown wherein the EPG server 112 communicates the compressed EPG data 410 to the client device 104.

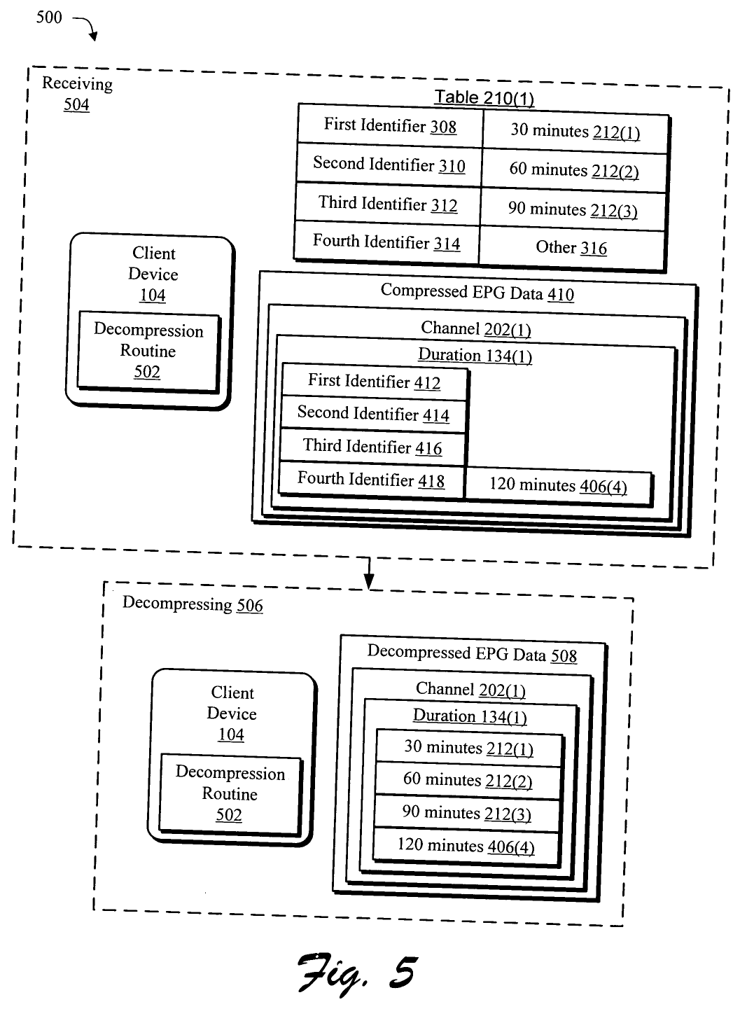

FIG. 5 illustrates an exemplary procedure 500 in which the client device 104 executes a decompression routine 502 to decompresses identifiers included in the compressed EPG data 410 of FIG. 4 using the table 210(1) generated in FIG. 3. At block 504, a receiving step is shown wherein the client device 104 receives the table 210(1) and the compressed EPG data 410. The table 210(1) includes identifiers 308-312 that reference values 212(1)-212(3) for the duration 134(1) characteristic. The table 210(1) also includes the fourth identifier 314, e.g. the read identifier, which indicates that the value for the fourth identifier 314 is to be read directly from the compressed EPG data 410.

At block 506, a decompressing step is shown wherein the client device 104 executes the decompression routine 502, which may be configured as software, to decompress the compressed EPG data 410 by using the table 210(1). The decompression routine 502, when executed, first analyzes the identifiers 412-418 in the compressed EPG data 410. If the identifier is a read identifier, the decompression routine 502 reads a value referenced by the read identifier directly from the compressed EPG data 410 without comparing the read identifier to the table 210(1). For example, the fourth identifier 418 in the compressed EPG data 410 when analyzed is determined to be a read identifier (it contains bits “11”) that indicates that a value that is referenced by the fourth identifier 418 is not included in the table 210(1). Rather, the value 120 minutes 406(4) referenced by the fourth identifier 418 is read directly from the compressed EPG data 410 itself.

If the identifier is not a read identifier (i.e. it contains bits other than “11,” such as “01,” “10,” or “00”), the decompression routine 502, when executed, compares the identifiers 412-416 contained in the compressed EPG data 410 with the identifiers 308-312 contained in the table 210(1). For example, the decompression routine 502, when executed, analyzes the first identifier 412 in the compressed EPG data 410. The first identifier 412 has bits “00” which indicate that the first identifier 412 is not a read identifier. Therefore, the decompression routine 502, when executed, compares the first identifier 412 with the identifiers 308-312 in the table 210(1). The first identifier 412 of the compressed EPG data 410 matches the first identifier 308 of the table 210(1). Therefore, the value 30 minutes 212(1) referenced by the first identifier 308 in the table 210(1) is output by the decompression routine 502. Similarly, the 60 minutes 212(2) and 90 minutes 212(3) values referenced by the matching second and third identifiers 310, 312 are output for the second and third identifiers 414, 416, respectively. Therefore, when the decompression routine 502 is executed by the client device 104, decompressed EPG data 508 may be obtained that includes the 30, 60 and 90 minutes values 212(1)-212(3) from the table 210(1) and the 120 minutes 404(4) value from the compressed EPG data 410. One or more of the values 212(1)-212(3) in the decompressed EPG data 410 may be output in an EPG. For example, each identifier may be decompressed when requested to supply a desired value that corresponds with the identifier. Thus, the compressed EPG data 410 may remain compressed in a memory of the client device 104 and the decompression routine 502, when executed, may decompress the identifiers when requested.

Although the table 210(1) included in the client device 104 is shown with the fourth identifier 314, in some implementations, the fourth identifier 314 is not included in the table 210(1) on the client device 104 to decrease the size of the table 210(1). For example, in the current implementation, the fourth identifier 314 included in the table 210(1) is not utilized to decompress identifiers contained in EPG data, i.e. identifiers are not compared with the fourth identifier 314. Instead, the fourth identifier 418 indicates that a value referenced by the identifier is included in the EPG data itself without performing the comparison. Therefore, the decompression routine 502 need not compare an identifier to the fourth identifier 314 in the table 210(1). For example, the decompression routine 502, when encountering bits “11” may output the next 12 bits in the compressed EPG data 410 automatically.

Even though the implementations discussed in relation to FIGS. 3-5 describe a table 210(1) generated from EPG data 106 that is different from the EPG data 402 that is compressed, the table 210(1) may be generated in a variety of ways. In another implementation, the table is generated for each specific set of EPG data that is to be communicated to the client device. For instance, EPG data which is to be used in a particular 36-hour period may have a table that corresponds to that particular 36-hour period. The table may then be communicated with the compressed EPG data to the client device. Additionally, the table may be communicated and stored on the client device before or after communicating the compressed EPG data, as will be further described in relation to FIGS. 12-13.

Computing a Broadcast Start Time for an Television Program

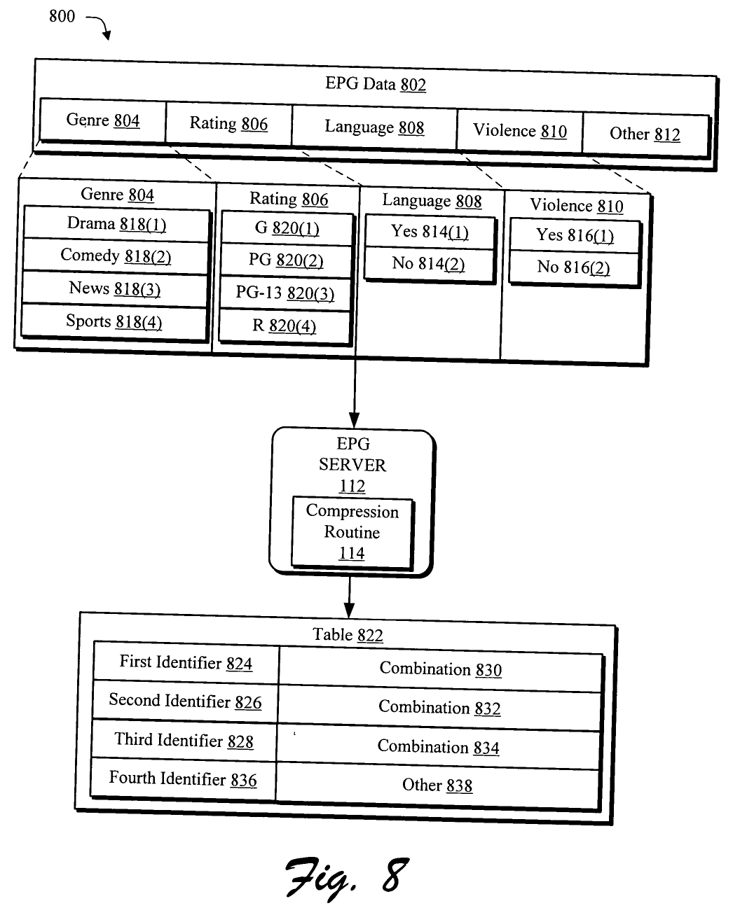

FIG. 7 is an illustration showing an exemplary implementation 700 of a master start time 702 which is suitable to be used to compute a broadcast start time for a television program. To further compress EPG data, the master start time 702 may be provided to compute a broadcast start time using the duration 134(1) characteristic for television programs 704-716. For example, to compute a broadcast start time for a desired television program 710, the client device 104 may execute software to determine that television program 704, television program 706 and television program 708 are to be broadcast between the master start time 702 and the desired television program 710. Determining may be accomplished in a variety of ways. In one implementation, values 204(1)-204(7) of the duration 134(1) characteristic of the television programs 704-716 are listed in chronological order, starting at the master start time 702.

A broadcast start time for the desired television program 710 is then computed by adding the corresponding values of the duration 134(1) for the television programs 704-708 to the master start time 702. In this instance, the values of 30 minutes 204(1), 60 minutes 204(2) and 90 minutes 204(3) are added to the master start time 702 to compute a start time for the desired television program 710. The broadcast start time for the desired television program 710 may then be output as part of an EPG by the client device. In this way, EPG data may be compressed by not including a separate start-time value for each television program included in the EPG data.

In instances in which a channel has a time period during which a television program is not broadcast, a value for the duration of the time period may be supplied to compute a start time for a subsequent television program that is to be broadcast after the time period. For example, a television program titled “no programming” may be supplied that has a corresponding duration of the amount of time that content is not being broadcast. Therefore, a start time for a television program to be broadcast after the “no programming” television program may be computed by adding a value for the duration of the “no broadcasting” television program to the master start time.

The broadcast start time may be computed by an EPG application, e.g. EPG application 1320 shown in FIG. 13, which is executable on a processor to compute the broadcast start time for the desired television program. The computed broadcast start time may be output as part of an EPG that is generated from EPG data by the EPG application. The client device may receive the EPG data including the master start time from a broadcast received from a head end. An example of a head end 1330 is shown in FIG. 13.

Compressing Combinations of Values

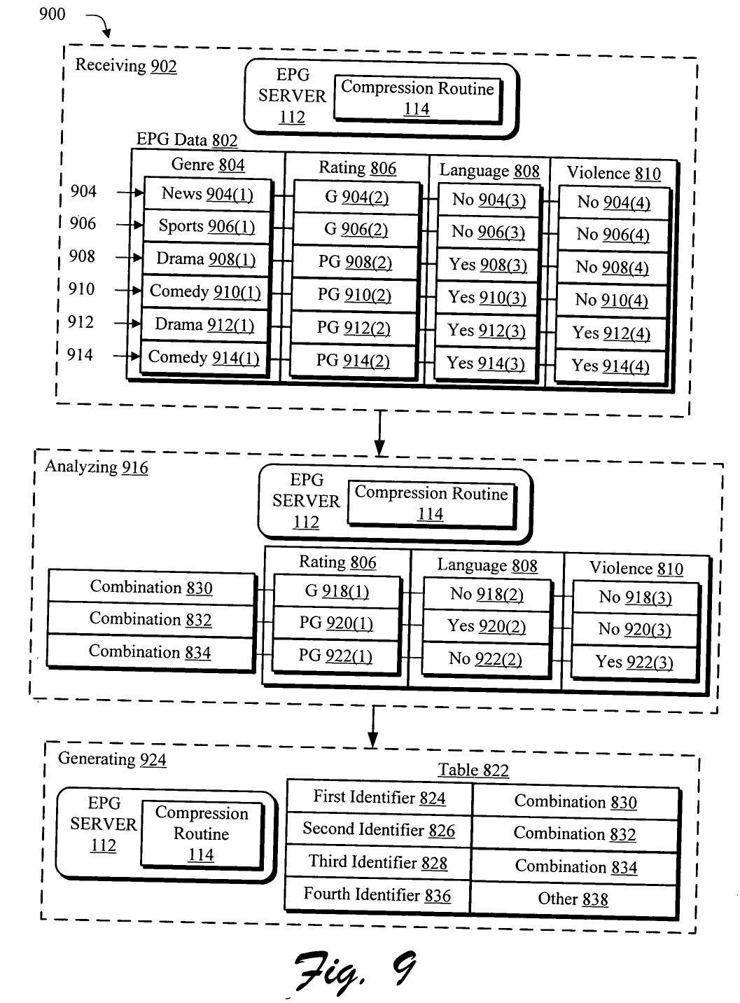

FIG. 8 is an illustration showing an exemplary implementation 800 of compressing combinations of values. In the previous exemplary implementations shown in FIGS. 2-6, values which were common to a single characteristic were described using an identifier. To further compress EPG data 802, unique combinations (combinations) of values of characteristics may also be described using an identifier.

EPG data 802, which may or may not be similar to the EPG data 106 shown in FIG. 1, may include a wide variety of characteristics, such as genre 804, rating 806, and so on. Characteristics may also be configured as content flags such as language 808, violence 810, and include other 812 content flags. Content flags indicate whether the television program contains or does not contain the characteristic. For instance, language 808 may include values of “yes” 814(1) or “no” 814(2) to indicate whether a television program contains adult language. Likewise, violence 810 may include values of “yes” 816(1) or “no” 816(2) to indicate whether a television program contains violence. Characteristics may also have more than two values. For example, genre 804 may include values that indicate whether a television program is a drama 818(1), a comedy 818(2), news 818(3), sports 818(4), and so forth. Rating 806 may include values such as G 820(1), PG 820(2), PG-13 820(3), and R 820(4).

Although a wide variety of characteristics are available to describe television programs, and each of those characteristics may have a range of values, combinations of characteristics and values may be common in the EPG data 802. The EPG server 112 may execute the compression routine 114 to generate a table 822 having identifiers 824-828 which reference combinations 830-834 of values for characteristics. In other words, identifiers 824-828 may reference combinations of characteristics having respective common values. Thus, the identifiers 824-828 may be utilized to describe more than one value. As described in the previous implementations in FIGS. 2-6, a fourth identifier 836 may also be included in the table 822 to indicate a value which is not included in the table 822, which is illustrated as “other” 838 in FIG. 8. Therefore, a value referenced by the fourth identifier 836 is not compressed and is included in the compressed EPG data.

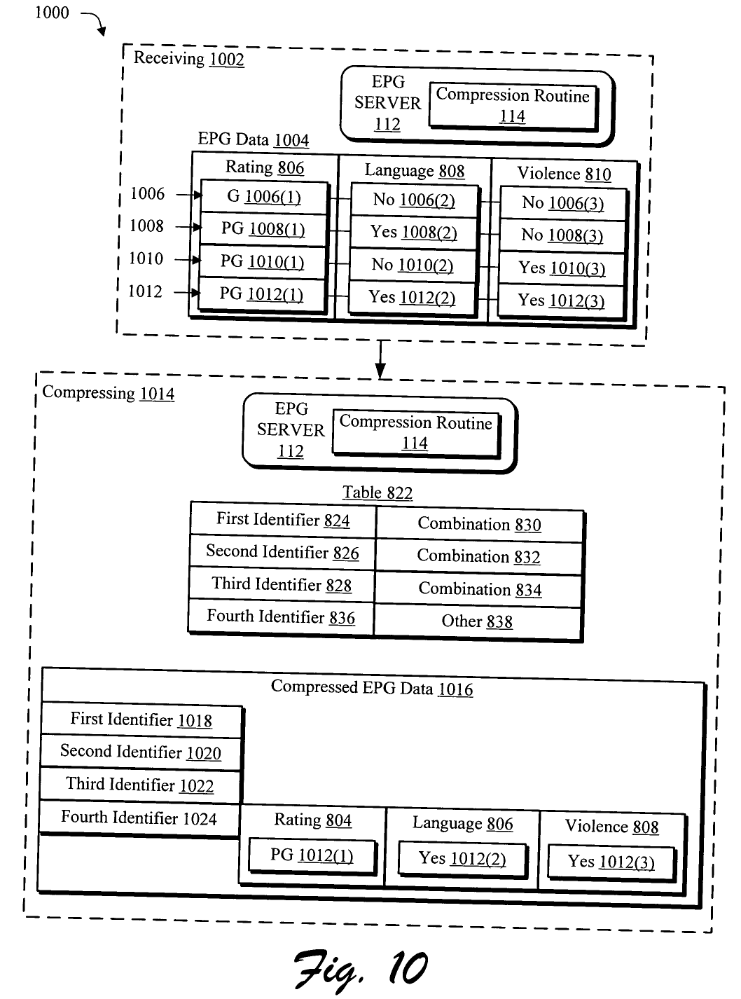

FIG. 9 is an illustration showing an exemplary procedure 900 in which the table 822 of FIG. 8 is generated that includes identifiers that reference combinations of values of characteristics. At block 902, a receiving step is shown wherein the EPG server 112 receives the EPG data 802. The EPG data 802 includes the characteristics genre 804, rating 806, language 808 and violence 810. The EPG data 802 is arranged to describe values of the characteristics 804-810 of a plurality of television programs 904, 906, 908, 910, 912, 914. To illustrate how the values correspond to each program, the values will share the first three numbers of the corresponding program's reference number. The values for the combinations will also share similar reference numbers to indicate values that are in the same combination.

A first television program 904 may include a value news 904(1) for genre 804, a value “G” 904(2) for rating 806, a value “no” 904(3) for language 808 and a value “no” 904(4) for violence 810. A second television program 906 may include a value sports 906(1) for genre 804, a value “G” 906(2) for rating 806, a value “no” 906(3) for language 808, and a value “no” 906(4) for violence 810. Likewise, third, fourth, fifth and sixth television programs [908, 910, 912, 914] include values [908(1)-908(4), 910(1)-910(4), 912(1)-912(4), 914(1)-914(4)] for the characteristics 804-810.

At block 916, an analyzing step is shown wherein the EPG server 112, through execution of the compression routine 114, analyzes the EPG data 802 to find combinations of values that are common for the respective characteristics. In the illustrated example, the combination 830 is found from analysis of the values 904(1)-904(4), 906(1)-906(4) of the first and second television programs 904, 906. The combination 830 includes a value “G” 918(1) for rating 806, a value “no” 918(2) for language 808 and a value “no” 918(3) for violence 810. The combination 832 is found from analysis of the values 908(1)-908(4), 910(1)-910(4) of the respective third and fourth television programs 908, 910. The combination 832 includes a value “PG” 920(1) for rating 806, a value “yes” 920(2) for language 808 and a value “no” 920(3) for violence 810. The combination 834 is found from analysis of the values 912(1)-912(4), 914(1)-914(4) of the respective fifth and sixth television programs 912, 914. The combination 834 includes a value “PG” 922(1) for rating 806, a value “no” 922(2) for language 808 and a value “yes” 922(3) for violence 810.

At block 924, a generating step is shown wherein the EPG server 112, through execution of the compression routine 114, generates the table 822 based on the analysis performed in block 916. The table 822 includes combinations 830, 832, 834 which are referenced with respective first, second and third identifiers 824, 826, 828. Although the table 822 is illustrated as having combinations 830-834, the values 918(1)-918(3), 920(1)-920(3), 922(1)-922(3) are included in the respective combinations 830, 832, 834 in the table 822. The table 822 may also include the fourth identifier 836 to indicate that a combination of values that is not included in the table 822, which is illustrated as “other” 838. The table 822 may be communicated to the client device 104 (FIG. 1) by the EPG server 112, such as by using the head end 118 and carousel file system 122 of FIG. 1.

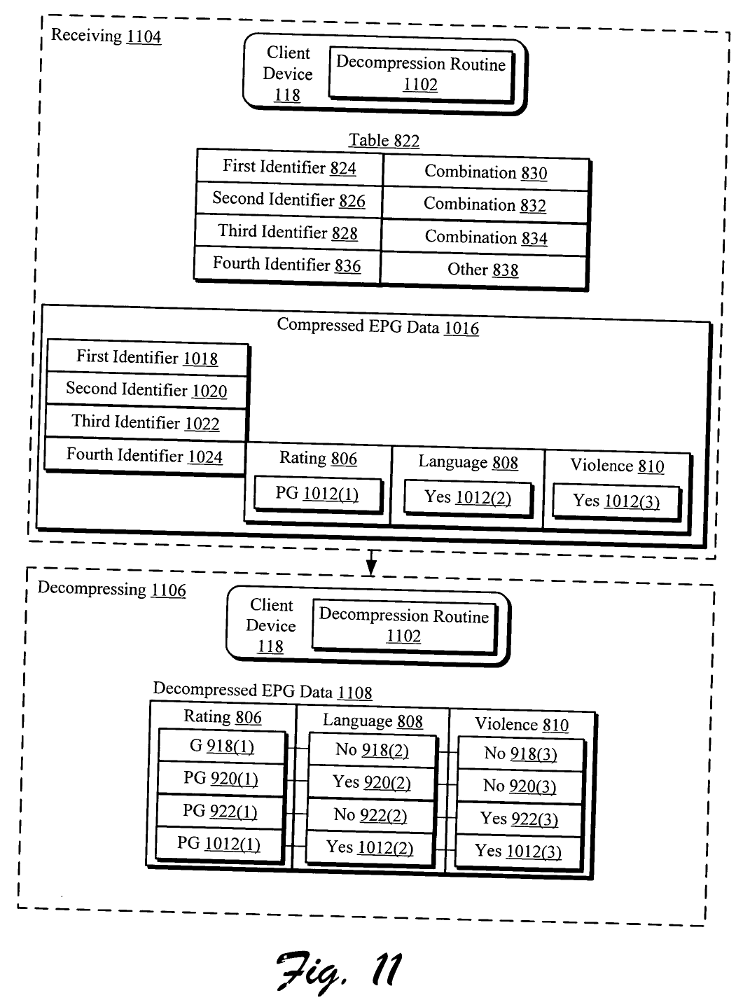

FIG. 10 is an illustration of an exemplary procedure 1000 for compressing EPG data using the table 822 of FIG. 9. At block 1002, a receiving step is shown wherein the EPG server 112 receives EPG data 1004 that includes the characteristics rating 806, language 808, and violence 810. A first television program 1006 includes a value “G” 1006(1) for rating 806, a value “no” 1006(2) for language 808 and a value “no” 1006(3) for violence 810. A second television program 1008 includes a value “PG” 1008(1) for rating 806, a value “yes” 1008(2) for language 808 and a value “no” 1008(3) for violence 810. A third television program 1010 includes a value “PG” 1010(1) for rating 806, a value “no” 1010(2) for language 808 and a value “yes” 1010(3) for violence 810. A fourth television program 1012 includes a value “PG” 1012(1) for rating 806, a value “yes” 1012(2) for language 808 and a value “yes” 1012(3) for violence 810.

At block 1014, a compressing step is shown wherein the EPG server 112 executes the compression routine 114 to compress the values in the EPG data 1004 to form compressed EPG data 1016. The compression routine 114, when executed, compares the values [1006(1)-1006(3), 1008(1)-1008(3), 1010(1)-1010(3), 1012(1)-1012(3)] in the EPG data 1004 with the values [918(1)-918(3), 920(1)-920(3), 922(1)-922(3)] in the respective combinations 830, 832, 834 shown in block 916 of FIG. 9. If the values [1006(1)-1006(3), 1008(1)-1008(3), 1010(1)-1010(3), 1012(1)-1012(3)] match one of the combinations 830, 832, 834 in the table 822, the values are replaced with an identifier that matches an identifier from the table 822 that references the combination. For example, the value “G” 1006(1) for rating 806, the value “no” 1006(2) for language 808 and the value “no” 1006(3) for violence 810 in the EPG data 1004 match the values 918(1)-918(3) in the combination 830 shown in block 916 of FIG. 9. Therefore, a first identifier 1018, which matches the first identifier 824, is used to replace the values 1006(1)-1006(3). Likewise, a second identifier 1020, which matches the second identifier 826, is used to replace the values 1008(1)-1008(3) in the EPG data 1004. A third identifier 1022, which matches the third identifier 828, is used to replace the values 1010(1)-1010(3) in the EPG data 1004. However, the values 1012(1)-1012(3) for the fourth television program 1012 do not match any of the values [918(1)-918(3), 920(1)-920(3), 922(1)-922(3),] in the combinations 830-834 shown in block 916 of FIG. 9. In other words, the values 1012(1)-1012(3) correspond to “other” 838 in the table 822. Therefore, a fourth identifier 1024, which matches the fourth identifier 836 in the table 822, is inserted into the compressed EPG data 1016. The fourth identifier 1024 indicates that the values 1012(1)-1012(3) are to be read directly from the compressed EPG data 1016 without having to compare the fourth identifier 1024 with the identifiers 824-828 in the table 822. The compressed EPG data 1016 may then be communicated to the client device 104 (FIG. 1) and decompressed using the table 822 generated in FIG. 9.

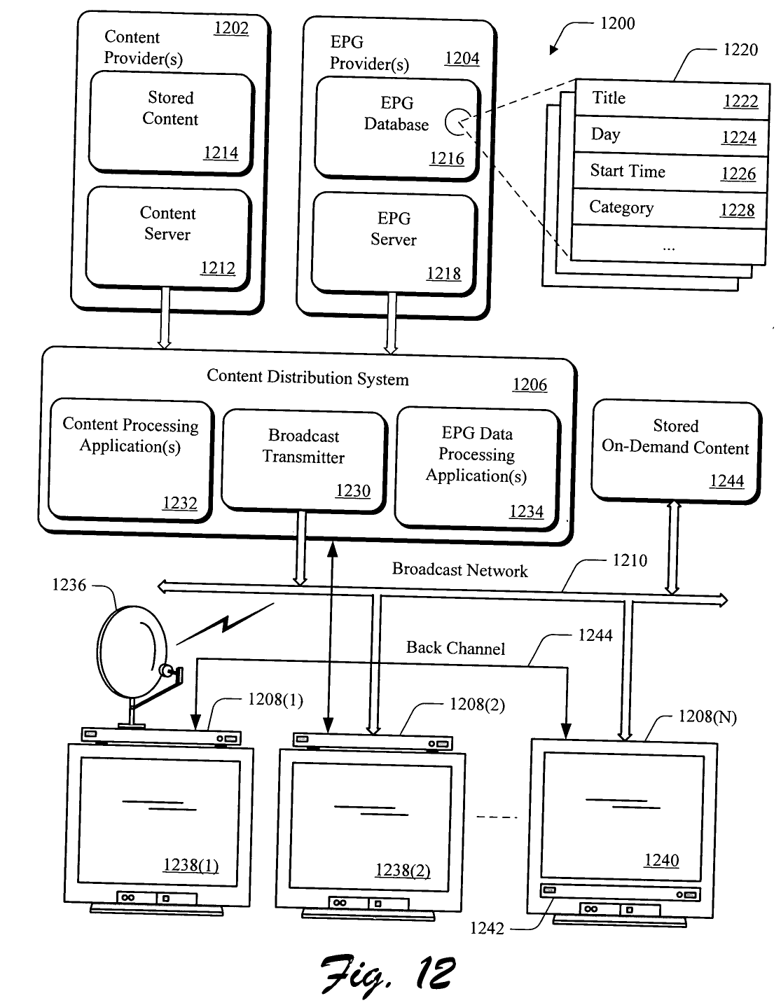

FIG. 11 is an illustration showing an exemplary procedure 1100 in which the client device 104 executes a decompression routine 1102 to decompress the compressed EPG data 1016 of FIG. 10 using the table 822 generated in FIG. 9. At block 1104, a receiving step is shown wherein the client device 104 receives the table 822 and the compressed EPG data 1016. The table 822 includes identifiers 824-828 that reference combinations 830-834 illustrated in FIG. 9 as having respective values 918(1)-918(3), 920(1)-920(3), 922(1)-922(3) for the characteristics 806-810.

At block 1106, a decompressing step is shown wherein the client device 104 executes the decompression routine 1102 to obtain decompressed EPG data 1018 by decompressing identifiers contained in the compressed EPG data 1016 using the table 822. The decompression routine 1102, when executed, compares the identifiers 1018-1024 contained in the compressed EPG data 1016 with the identifiers 824-828, 836 contained in the table 822. For example, the decompression routine 1102, when executed, compares the first identifier 1018 of the compressed EPG data 1016 with the identifiers 824-828, 836 in the table 822. The first identifier 1018 in the compressed EPG data 1016 matches the first identifier 824 of the table 822. The values 918(1)-918(3) are referenced by the first identifier 824. Therefore, the values 918(1)-918(3) in the combination 830 are output. Similarly, the values 920(1)-920(3), 922(1)-922(3) (FIG. 9) are output, which are referenced by the second and third identifiers 826, 828 that match the second and third identifiers 1020, 1022, respectively.

The fourth identifier 1024 in the compressed EPG data 1016, when compared with the fourth identifier 836 in the table 822, indicates that values that are referenced by the fourth identifier 1024 are not included in the table 822. Therefore, the values 1012(1)-1012(3) for the characteristics 806, 808, 810 are read directly from the compressed EPG data 1016 itself. Although in this implementation, the fourth identifier 1024 is compared with the fourth identifier 836 in the table 822 (and therefore is not a read identifier), in other implementations, analysis of whether the identifiers are read identifiers may also be performed, as described in the implementations corresponding to FIGS. 2-6. Additionally, in such an implementation, the fourth identifier 926(4) may be omitted from the table 822 when stored in the client device 104 as previously described.

The table 822, like the table 210(1) described previously in relation to FIGS. 3-5, may be generated in a variety of ways. For example, the table 822 may be generated for each particular set of EPG data that is to be communicated to the client device. Additionally, the table 822 may be generated from a different set of EPG data than the EPG data with which the table 822 will be utilized to compress. As illustrated in FIGS. 9-10 for instance, the table 822 can be generated from one set of EPG data 802 and used to decompress another set of EPG data 1004. Further, the table 822 may be communicated and stored on the client device 104 before or after communicating the compressed EPG data, as will be further described in relation to FIGS. 12-13.

Exemplary Environment

FIG. 12 illustrates an exemplary television entertainment system 1200 in which EPG data compression and decompression may be implemented. System 1200 facilitates distribution of television programming, such as content, and EPG data to multiple viewers, and includes components to further facilitate EPG data compression. The system 1200 includes one or more content providers 1202, one or more EPG providers 1204, a content distribution system 1206, and multiple client devices 1208(1), 1208(2), . . . , 1208(N) coupled to the content distribution system 1206 via a broadcast network 1210. The client devices 1208(1)-1208(N) and broadcast network 1210 can either be the same as or different from the client devices 104 and broadcast network 124 shown in FIG. 1.

Content provider 1202 includes a content server 1212 and stored television programming, such as content 1214. Content server 1212 controls distribution of the stored content 1214 from content provider 1202 to the content distribution system 1206. Additionally, content server 1212 controls distribution of live content (e.g., content that was not previously stored, such as live feeds) and/or content stored at other locations to the content distribution system 1206. EPG provider 1204 includes an EPG database 1216 and an EPG server 1218. The EPG database 1216 stores electronic files of EPG data which are used to generate an EPG. The EPG provider 1204 may also obtain EPG data from other sources, such as the publisher 102 shown in FIG. 1. The EPG provider 1204, EPG database 126 and EPG server 1218 can either be the same as or different from the EPG provider 108, EPG database 110 and EPG server 112 shown in FIG. 1.

An electronic file maintains EPG data 1220 that may include a title 1222, day(s) 1224 to identify which days of the week a television program will be shown, start times(s) 1226 to identify a time that a television program will be shown on the particular day or days of the week, rating, duration, channel, principle protagonist's name, language, year made, violence and a category 1228. A category, which may be considered a type of characteristic, describes the genre of a television program and categorizes it as a particular television program type. For example, a television program can be categorized as a movie, a comedy, a sporting event, a news program, a sitcom, a talk show, or as any number of other category descriptions. Additionally, EPG data 1220 may include video-on-demand information, such as movie schedules, as well as application information, such as for interactive games, and other programming information that may be of interest to a viewer.

The EPG server 1218 processes the EPG data 1220 prior to distribution to generate a published version of the EPG data which can contain programming information for all broadcast channels and on-demand content listings for one or more days. The processing may involve any number of techniques to reduce, modify, or enhance the EPG data 1220. Such processes might include selection of television programs, television program compression, format modification, and the like. The EPG server 1218 controls distribution of the published version of the EPG data from EPG provider 1204 to the content distribution system 1206 using, for example, a file transfer protocol (FTP) over a TCP/IP network (e.g., Internet or Intranet). Further, the published version of the EPG data can be transmitted from EPG provider 1204 via a satellite and the content distribution system 1206 directly to a client device 1208. 100711 Content distribution system 1206 includes a broadcast transmitter 1230, one or more content processing applications 1232, and may contain one or more EPG data processing applications 1234. Broadcast transmitter 1230 broadcasts signals, such as cable television signals, across broadcast network 1210. Broadcast network 1210 can include a cable television network, RF, microwave, satellite, and/or data network, such as the Internet, and may also include wired or wireless media using any broadcast format or broadcast protocol. Additionally, broadcast network 1210 can be any type of network, using any type of network topology and any network communication protocol, and can be represented or otherwise implemented as a combination of two or more networks.

A content processing application 1232 processes the content received from content provider 1202 prior to transmitting the content across broadcast network 1210. Similarly, the EPG data processing application 1234 processes the EPG data received from EPG provider 1204 prior to transmitting the EPG data across broadcast network 1210. A particular content processing application 1232 may encode, or otherwise process, the received content into a format that is understood by the multiple client devices 1208(1), 1208(2), . . . , 1208(N) coupled to broadcast network 1210. Although FIG. 12 shows a single content provider 1202, a single EPG provider 1204, and a single content distribution system 1206, exemplary system 1200 can include any number of content providers and/or EPG data providers coupled to any number of content distribution systems.

Content distribution system 1206 is representative of a head end that provides EPG data, as well as content, to multiple subscribers. Each content distribution system 1206 may receive a slightly different version of the EPG data that takes into account different programming preferences and lineups. The EPG server 1218 may create different versions of an EPG that includes those channels of relevance to respective head end services, and the content distribution system 1206 transmits the EPG data to the multiple client devices 1208(1), 1208(2), . . . , 1208(N). In one implementation, for example, content distribution system 1206 utilizes a carousel file system to repeatedly broadcast the EPG data over an out-of-band (OOB) channel to the client devices 1208. Alternatively, the multiple client devices 1208(1), 1208(2), . . . , 1208(N) can receive standard, or uniform, EPG data and individually determine the EPG data to display based on the associated head end service.

Client devices 1208 can be implemented in a number of ways. For example, a client device 1208(1) receives content broadcast from a satellite-based transmitter via a satellite dish 1236. Client device 1208(1) is also referred to as a set-top box or a satellite receiving device. Client device 1208(1) is coupled to a television 1238(1) for presenting the content received by the client device (e.g., audio data and video data), as well as a graphical user interface. A particular client device 1208 can be coupled to any number of televisions 1238 and/or similar devices that can be implemented to display or otherwise render content. Similarly, any number of client devices 1208 can be coupled to a single television 1238.

Client device 1208(2) is also coupled to receive content broadcast from broadcast network 1210 and provide the received content to associated television 1238(2). Client device 1208(N) is an example of a combination television 1240 and integrated set-top box 1242. In this example, the various components and functionality of the set-top box are integrated into the television, rather than using two separate devices. The set-top box integrated into the television can receive broadcast signals via a satellite dish (similar to satellite dish 1236) and/or via broadcast network 1210. In alternate implementations, client devices 1208 may receive broadcast content via the Internet or any other broadcast medium, such as back channel 1244 which can be implemented as a Internet protocol (IP) connection or as other protocol connections using a modem connection and conventional telephone line, for example. Further, back channel 1244 provides an alternate communication link between each of the client devices 1208, and between the client devices 1208 and the content distribution system 1206.

The exemplary system 1200 also includes stored on-demand content 1244, such as Video On-Demand (VOD) movie content. The stored on-demand content can be viewed with a television 1238 via a client device 1208 through an onscreen EPG, for example, and a viewer can enter instructions to stream a particular movie, or other stored content, to a corresponding client device 1208.

Exemplary EPG Data Compression System

FIG. 13 illustrates an exemplary EPG data compression system 1300 that includes selected components of television system 1200, such as an exemplary client device 1208 and a television 1238. Client device 1208 includes components to implement EPG data decompression in a television-based entertainment and information system. Client device 1208 can be implemented as a set-top box, a satellite receiver, a TV recorder with a hard disk, a digital video recorder (DVR) and playback system, a personal video recorder (PVR) and playback system, a game console, an information appliance, and as any number of similar embodiments.

Client device 1208 includes one or more tuners 1302 which are representative of one or more in-band tuners that tune to various frequencies or channels to receive television signals, as well as an out-of-band tuner that tunes to the broadcast channel over which the EPG data is broadcast to client device 1208. Client device 1208 also includes one or more processors 1304 (e.g., microprocessors) which process various instructions to control the operation of client device 1208 and to communicate with other electronic and computing devices.

Client device 1208 can be implemented with one or more memory components, examples of which include a random access memory (RAM) 1306, mass storage media 1308, a disk drive 1310, and a non-volatile memory 1312 (e.g., ROM, Flash, EPROM, EEPROM, etc.). The memory components (e.g., RAM 1306, storage media 1308, disk drive 1310, and non-volatile memory 1312) store various information and/or data such as received content, EPG data 1314, configuration information for client device 1208, and/or graphical user interface information.

Alternative implementations of client device 1208 can include a range of processing and memory capabilities, and may include any number and different memory components than those illustrated in FIG. 13. For example, full-resource clients can be implemented with substantial memory and processing resources, including the disk drive 1310. Low-resource clients, however, may have limited processing and memory capabilities, such as a limited amount of RAM 1306 and limited processing capabilities of a processor 1304.

An operating system 1316 and one or more application programs 1318 can be stored in non-volatile memory 1312 and executed on a processor 1304 to provide a runtime environment. A runtime environment facilitates extensibility of client device 1208 by allowing various interfaces to be defined that, in turn, allow application programs 1318 to interact with client device 1208. The application programs 1318 that may be implemented in client device 1208 can include a browser to browse the Web (e.g., “World Wide Web”), an email program to facilitate electronic mail, and so on.

An EPG application 1320 is stored in memory 1312 to process the EPG data 1314 and generate an EPG. The EPG application 1320 utilizes the EPG data 1314 and enables a television viewer to navigate through an onscreen EPG and locate television shows, video on-demand movies, interactive game selections, and other media access information of interest to the viewer. With the EPG application 1320, the television viewer can look at schedules of current and future programming, set reminders for upcoming programs, and/or enter instructions to record one or more television shows or video on-demand movies. Further, the EPG application 1320 may be used to compute the start time as described in relation to FIG. 7.

Client device 1208 further includes one or more communication interfaces 1322 and a PSTN, DSL, or cable modem 1324. A communication interface 1322 can be implemented as a serial and/or parallel interface, as a wireless interface, and/or as any other type of network interface. A wireless interface enables client device 1208 to receive input commands and other information from a user-operated input device, such as from a remote control device or from another infrared (IR), 802.11, Bluetooth, or similar RF input device. Input devices can include a wireless keyboard or another handheld input device such as a personal digital assistant (PDA), handheld computer, wireless phone, or the like. A network interface and a serial and/or parallel interface enables client device 1208 to interact and communicate with other electronic and computing devices via various communication links. Modem 1324 facilitates client device 1208 communication with other electronic and computing devices via a conventional telephone line, a DSL connection, or a cable modem.

Client device 1208 also includes a content processor and/or decoder 1326 to process and decode broadcast video signals, such as NTSC, PAL, SECAM, or other television system analog video signals, as well as a DVB, ATSC, or other television system digital video signals. Content processor 1326 can also include a video decoder and/or additional processors to receive, decode, and/or process video content received from content distribution system 1206 (FIG. 12) which is representative of a head end service that provides EPG data, as well as content, to multiple client devices 1208. Content processor 1326 can include an MPEG-2 or MPEG-4 (Moving Pictures Experts Group) decoder that decodes MPEG-encoded video content. MPEG supports a variety of audio/video formats, including legacy TV, HDTV (high-definition television), DVD (digital versatile disc), and five-channel surround sound.

Typically, video content includes video data and audio data that corresponds to the video data. Content processor 1326 generates video and/or display content that is formatted for display on display device 1238, and generates decoded audio data that is formatted for output by an audio device, such as one or more speakers (not shown) in display device 1238. Content processor 1326 can include a display controller (not shown) that processes the video and/or display content to display corresponding images on display device 1238. A display controller can include a microcontroller, integrated circuit, and/or similar video processing component to process the images. Client device 1208 also includes an audio and/or video output 1328 that provides the video and/or display signals to television 1238 or to other devices that process and/or display, or otherwise render, the audio and video data. It is to be noted that the systems and methods described herein can be implemented for any type of encoding format as well as for data and/or content streams that are not encoded.

Although shown separately, some of the components of client device 1208 may be implemented in an application specific integrated circuit (ASIC). Additionally, a system bus (not shown) typically connects the various components within client device 1208. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

The exemplary EPG data compression system 1300 also includes a head end 1330 as an implementation of content distribution system 1206 (FIG. 12) which is representative of a head end that provides EPG data 1332, as well as content, to client device 1208. Head end 1330 includes an EPG application 1334 (e.g., an EPG data processing application 1234 as shown in FIG. 12) implemented to process EPG data 1332 as well as implement the EPG data compression procedures described herein, such as combining values in a field, unique combinations of values and use of a master start time.

The EPG application 1334 can be implemented as a software component that executes on a processor and is stored in a non-volatile memory device in head end 1330. Although EPG application 1334 is illustrated and described as a single application configured to perform several functions of EPG data compression, the EPG application 1334 can be implemented as several component applications distributed to each perform one or more functions in a computing device, a digital video recorder system, a personal video recorder system, and/or any other television-based entertainment and information system.

The EPG application 1334 generates a table 1336 including identifiers and values found in the EPG data 1332. The table 1336 may be generated by the head end 1330 with the EPG application 1334 when the head end generates the EPG data for an arbitrary time period and compresses the EPG data for communication to the client device 1208 via broadcast network 1210. In another implementation, the table 1336 may be generated and stored by the client device 1208 for use in generating a plurality of EPGs. Client device 1208 may receive compressed EPG data 1338 from head end 1330 and store the compressed EPG data 1338 and the associated table 1340 in disk drive 1310 and/or non-volatile memory 1312. Although this example describes compressing the EPG data before transmitting the EPG data to reduce transmission bandwidth, client device 1208 may also receive EPG data and then generate the table, as well as compress the EPG data, to reduce the memory storage space needed to maintain, or otherwise store, the EPG data.

Conclusion Althourgh the invention has been decribed in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising compressing electronic program guide (EPG) data that includes a plurality of television programs, each television program having one or more values, each said value describing a television program characteristic, the EPG data being compressed by:
comparing the one or more values of each said television program with unique combinations of values to find a match, wherein each value in each unique combination describes a television program characteristic, wherein each said unique combination is in a table that includes a plurality of identifiers, and wherein each said identifier references one said unique combination; and
for each said match, replacing the one or more values of the corresponding television program in the EPG data with the identifier in the table that references the matching unique combination of values.

2. A method as described in claim 1, further comprising generating the table by analyzing the EPG data or a different set of EPG data.

3. A method as described in claim 1, further comprising generating the table, wherein the generating minimizes the amount of memory used to store the table by selecting each said unique combination of values based on the amount of memory used to store the unique combinations of values.

4. A method as described in claim 1, wherein each said television program characteristic having a corresponding valuse in the EPG data is selected from the group consisting of:
genre;
title;
rating;
duration;
channel;
principle protagonist's name;
language;
year made;
broadcast day; and
violence.

5. A method as described in claim 1, further comprising communicating the table and the compressed EPG data to a client device.

6. A head end comprising a processor executing a program for performing the method of claim 1.

7. One or more computer-readable media comprising computer-executable instructions that, when executed, perform the method as recited in claim 1.

8. A method comprising:
receiving a table that includes unique combinations of values that describe respective television program characteristics and a plurality of identifiers each referencing one said unique combination;
receiving compressed electronic program guide (EPG) data including a plurality of television programs, each television program having one or more identifiers: and
comparing the one or more identifiers of the television program with the identifiers in the table, and when there is a match, outputting at least one value of the unique combination of values referenced by the matching identifier in the table.

9. A method as described in claim 8, wherein the compressed EPG data and the table are received from an EPG server.

10. A method as described in claim 8, wherein:
a client device performs the receiving of the compressed EPG data and the comparing; and
the table is received by the client device from a manufacturer of the client device.

11. A method as described in claim 8, wherein the receiving of the compressed EPG data is performed before or after the receiving of the table.

12. A client device comprising a processor executing a program for performing the method of 8.

13. One or more computer-readable media comprising computer-executable instructions that, when executed, perform the method as recited in claim 8.

14. A method comprising compressing electronic program guide (EPG) data that includes a plurality of television programs, each television program having one or more values that respectively describe one or more television program characteristics, the EPG data being compressed by:
comparing the one or more values of each television program with values in a table that describe a television program characteristic, wherein each said value in the table is referenced by an identifier, wherein:
when the one or more values of each television program match one of the values in the table, then replacing the one or more values of each television program with an identifier that matches the identifier that references the matching value in the table; and
when the one or more values of each television program do not match any of the values in the table, then inserting a read identifier with the one or more values of each television program in the EPG data, wherein the read identifier references the one or more values of each television program.

15. A method as described in claim 14, wherein the read identifier, when analyzed by a client device, indicates to the client device that the one or more values for the corresponding said television program are in the compressed EPG data.

16. A method as described in claim 14, further comprising generating the table by analyzing the EPG data or a different set of EPG data.

17. A method as described in claim 14, further comprising generating the table, wherein the generating optimizes the table by selecting the values in the table based on an amount of memory used to store values of television programs in the EPG data that correspond to the values in the table.

18. A method as described in claim 14, wherein the television program characteristics are selected from the group consisting of:
genre;
title;
rating;
duration;
channel;
protagonist's name;
language;
year made;
day; and
violence.

19. A method as described in claim 14, further comprising communicating the compressed EPG data to a client device.

20. A head end comprising a processor executing a program for performing the method of 14.

21. One or more computer-readable media comprising computer-executable instructions that, when executed, perform the method as recited in claim 14.

22. A method comprising:
receiving a table that includes values that describe a television program characteristic, wherein the table includes a plurality of identifiers each referencing one said value;
receiving compressed electronic program guide (EPG) data, the compressed EPG data including a plurality of television programs, each television program having one or more identifiers, wherein each identifier of the plurality of television programs is configured as at least one of:
a read identifier that references a value contained in the compressed EPG data; and
an identifier that matches at least one of the plurality of identifiers included in the table; and
analyzing an identifier of a television program in the compressed EPG data, wherein:
if the identifier of the television program is a read identifier, then outputting the value referenced by the read identifier from the compressed EPG data; and
if the identifier of the television program is not a read identifier, then comparing the identifier of the television program to the identifiers in the table, and when there is a match, outputting the value referenced by the matching identifier from the table.

23. A method as described in claim 22, wherein the receiving of the compressed EPG data, the receiving of the table, and the analyzing are performed by a client device.

24. A method as described in claim 22, wherein the compressed EPG data and the table are received from a head end.

25. A method as described in claim 22, wherein:
a client device performs the receiving of the compressed EPG data and the analyzing; and
the table is received by the client device from a manufacturer of the client device.

26. A method as described in claim 22, wherein the receiving of the compressed EPG data is performed before or after the receiving of the table.

27. One or more computer-readable media comprising computer-executable instructions that, when executed, perform the method as recited in claim 22.

28. A client device comprising:
a processor; and
a memory that is configured to maintain:
a table that includes unique combinations of values that describe respective television program characteristics and a plurality of identifiers each referencing one said unique combination;
compressed electronic program guide (EPG) data including a plurality of television programs, each television program having one or more identifiers; and
a decompression routine that is executable on the processor to decompress the compressed EPG data by:
comparing the one or more identifiers of the television programs with the identifiers in the table, and when there is a match, outputting at least one value of the unique combination of values referenced by the matching identifier in the table.

29. A client device comprising:
a processor; and
a memory that is configured to maintain:
a table that includes values that describe a television program characteristic, wherein the table includes a plurality of identifiers each referencing one said value;
compressed electronic program guide (EPG) data including a plurality of television programs, each television program having one or more identifiers, wherein each identifier of the plurality of television programs in the compressed EPG data is configured as at least one of:
a read identifier that references a value contained in the compressed EPG data; and
an identifier that matches at least one of the plurality of identifiers included in the table; and
a decompression routine that is executable on the processor to decompress the compressed EPG data by analyzing the identifier, wherein:
if the identifier of the television program is a read identifier, then outputting the value referenced by the read identifier from the compressed EPG data; and
if the identifier of the television program is not a read identifier, then comparing the identifier of the television program to the identifiers in the table, and when there is a match, outputting a value referenced by the matching identifier from the table.

30. An electronic program guide (EPG) server comprising:
a processor; and
a memory that is configured to maintain:
a table that includes unique combinations of values that describe respective television program characteristics and a plurality of identifiers each referencing one said unique combination;
electronic program guide (EPG) data that includes a plurality of television programs, each television program having one or more values that respectively describe one or more television program characteristics; and
a compression routine that is executable on the processor to compress the EPG data by:
comparing the one or more values of each television program with the unique combinations of values in the table to find a match; and
for each said match, replacing the one or more values of the television program with an identifier that matches the identifier in the table that references the unique combinations of values.

31. An EPG server as described in claim 30, wherein the compression routine is further configured to generate the table by analyzing the values of television program characteristics contained in the EPG data.

32. An EPG server as described in claim 30, wherein the compression routine is further configured to generate the table from the EPG data or a different set of EPG data.

33. An EPG server as described in claim 30, wherein the compression routine is further configured to form a transmission to communicate the table and the compressed EPG data to a client device.

34. An electronic program guide (EPG) server comprising:
a processor; and
a memory that is configured to maintain:
a table that includes values that describe a television program characteristic, wherein the table includes a plurality of identifiers each referencing one said value;
electronic program guide (EPG) data that includes a plurality of television programs, each television program having one or more values that respectively describe one or more television program characteristics; and
a compression routine executable on the processor to compress EPG data by comparing the one or more values of each television program with values in the table, wherein:
when the one or more values of each television program match one of the values in the table, then replacing the one or more values of each television program with an identifier that matches the identifier that references the matching value in the table; and
when the one or more values of each television program do not match any of the values in the table, then inserting a read identifier with the one or more values of each television program in the EPG data, wherein the read identifier references the one or more values of each television program.

35. An EPG server as described in claim 34, wherein the compression routine is further configured to generate the table from the EPG data or a different set of EPG data.

36. An EPG server as described in claim 34, wherein the compression routine is further configured to generate the table by analyzing the one or more values of each television program contained in the EPG data.

37. A system comprising:
an electronic program guide (EPG) server including a memory, a processor, and a compression routine that is stored in the memory and executable on the processor to compress electronic program guide (EPG) data that includes a plurality of television programs, each television program having one or more values that respectively describe one or more television program characteristics, by:
comparing the one or more values of each television program with unique combinations of values that describe respective television program characteristics to find a match, wherein each said unique combination is in a table that includes a plurality of identifiers each referencing one said unique combination; and
for each said match, replacing the one or more values of the television program with an identifier that matches the identifier in the table that references the unique combinations of values; and
a client device including a memory, a processor, and a decompression routine that is stored in the memory and executable on the processor to decompress compressed electronic program guide (EPG) data received from the EPG server over a network using a table corresponding to the table that was used to compress the compressed EPG data, by:
comparing the one or more identifiers of the television programs in the compressed EPG with the identifiers in the table; and
when there is a match, outputting at least one value of the unique combination of values referenced by the matching identifier in the table.

38. A system comprising:
an electronic program guide (EPG) server including a memory, a processor, and a compression routine that is stored in the memory and executable on the processor to compress electronic program guide (EPG) data that includes a plurality of television programs, each television program having one or more values that respectively describe one or more television program characteristics, by:
comparing the one or more values of each television program with values in a table that describe a television program characteristic, wherein each said value in the table is referenced by an identifier, wherein:
when the one or more values of each television program match one of the values in the table, then replacing the one or more values of each television program with an identifier that matches the identifier that references the matching value in the table; and
when the one or more values of each television program do not match any of the values in the table, then inserting a read identifier with the one or more values of each television program in the EPG data, wherein the read identifier references the one or more values of each television program; and
a client device communicatively coupled to the EPG server over a network, the client device including a memory, a processor, and a decompression routine that is stored in the memory and executable on the processor to decompress the compressed EPG data using a table corresponding to the table that was used to compress the compressed EPG data, by analyzing the one or more identifiers, wherein:
if the identifier of the television program is a read identifier, then outputting the value referenced by the read identifier from the compressed EPG data; and
if the identifier of the television program is not a read identifier, then comparing the identifier of the television program to the identifiers in the table, and when there is a match, outputting a value referenced by the matching identifier from the table.

39. A method comprising:
computing a broadcast start time, by a client device, for a desired television program on a channel by adding to a master start time a value of a duration television program characteristic of each television program scheduled on the channel between the master start time and the desired television program; and
outputting the broadcast start time for the desired television program in an electronic program guide (EPG).

40. A method as described in claim 39, wherein the master start time and the value of the duration television program characteristic of each television program is included in EPG data that is communicated to the client device from an EPG server.

41. A method as described in claim 39, wherein the adding further comprises adding each value of the duration television program characteristic, starting from the master start time, to the master start time until the value of the duration television program characteristic of the desired television program is reached.

42. One or more computer-readable media comprising computer-executable instructions that, when executed, perform the method as recited in claim 39.

43. A client device comprising:
a processor; and
a memory that is configured to maintain:
a master start time;
electronic program guide (EPG) data that includes a plurality of television programs that are to be broadcast on a channel, each television program having a value that describes a duration television program characteristic; and
an EPG application executable on the processor to compute a broadcast start time for a desired television program included in the plurality of television programs by adding to the master start time the value of the duration television program characteristic for each television program scheduled between the master start time and the desired television program.

44. A client device as described in claim 43, wherein the master start time and the value of the duration television program characteristic is received in EPG data that is communicated from an EPG server.

45. A client device as described in claim 43, wherein the adding further comprises adding each value of the duration television program characteristic, starting from the master start time, to the master start time until the value of the duration television program characteristic of the desired television program is reached.

46. A head end comprising:
a processor;
a memory that is configured to maintain:
a master start time; and
electronic program guide (EPG) data that includes a plurality of television programs that are to be broadcast on a channel, each television program having a value of a duration television program characteristic; and
a broadcast transmitter for broadcasting a transmission to a client device that includes the master start time and the EPG data, wherein the transmission enables the client device to compute a broadcast start time for a desired television program in the EPG by adding to the master start time the value of the duration television program characteristic for each television program scheduled between the master start time and the desired television program.
